(19) United States
(12) Patent Application Publication
(10) Pub. No.: US 2022/0260392 A1
(43) Pub. Date: Aug. 18, 2022

(54) ELECTRODYNAMIC POSITION TRANSDUCER

(71) Applicant: ELBI INTERNATIONAL S.P.A., Torino (IT)

(72) Inventors: Giorgio Carrer, Torino (IT); Marco Becchio, Carignano (Torino) (IT); Andrea Blengino, Villanova Canavese (Torino) (IT); Paolo Ravedati, Moncalieri (Torino) (IT)

(73) Assignee: ELBI INTERNATIONAL S.p.A., Torino (IT)

(21) Appl. No.: 17/672,022

(22) Filed: Feb. 15, 2022

(30) Foreign Application Priority Data
Feb. 16, 2021 (IT) 102021000003461

(51) Int. Cl. G01D 5/20; H01F 7/08

(52) U.S. Cl. CPC G01D 5/2006; H01F 7/081

(57) ABSTRACT

An electrodynamic position transducer has a casing in which a membrane is clamped, the membrane with a portion of the casing defining at least one chamber of variable volume, a coil having at least one conductive track formed on a coil support, and an interaction element configured to interact magnetically with the coil as a result of a movement of the membrane, in such a way that self-inductance of the coil is variable depending on a relative position of the interaction element with respect to the coil. A circuit, coupled to the coil, provides electrical signals, a parameter of the electrical signals being indicative of the self-inductance of the coil. A hole or recess is formed in the coil support and is configured to receive the interaction element in such a way that one end of the interaction element is positionable flush with or beyond a turn of the coil.

### CROSS REFERENCE TO RELATED APPLICATION

This application claims priority to and benefit of Italian Patent Application No. 102021000003461, filed on Feb. 16, 2021, which is fully incorporated by reference herein in its entirety.

### FIELD OF THE INVENTION

The present invention relates to an electrodynamic position transducer which may be used, for example, as a pressure transducer in washing machines or dishwashers, gas boilers for heating and other domestic appliances.

More specifically, the present invention relates to a transducer comprising

a rigid, hollow casing in which a membrane is clamped which, together with a portion of the rigid, hollow casing, defines at least one chamber of variable volume;

a coil comprising at least one turn formed by a pattern of flat conductive tracks formed on a coil support made of insulating material;

an interaction element configured to interact magnetically with the coil as a result of a movement of the membrane, in such a way that the self-inductance of the coil may be varied depending on the relative position of the interaction element with respect to the coil, and

circuit means coupled to the coil and configured to provide an output signal, a parameter of the output signal being indicative of the self-inductance of the coil.

### BACKGROUND OF THE INVENTION

U.S. Pat. No. 7,180,285 B2 describes a conventional transducer in which the coil is made by winding a copper wire.

WO 2018/171998 A1 describes a transducer of the kind defined above in which the coil is a planar spiral coil, and the interaction element is also a planar element positioned in front of the coil.

### SUMMARY OF THE INVENTION

The object of the present invention is to provide a transducer which has a more compact structure and which is cheaper and more reliable compared to conventional transducers such as the device described in U.S. Pat. No. 7,180,285 B2.

A further object of the present invention is to provide a transducer able to achieve better performance than the device described in WO 2018/171998 Al.

In view of these objects, the present invention relates to a transducer of the kind defined at the outset in which a hole or recess is formed in the coil support. The hole or recess is configured to receive the interaction element in such a way that one end of the interaction element may be positioned flush with the at least one turn or beyond the at least one turn.

By comparison with conventional devices, the transducer according to the present invention has the following advantages:

the processes of winding and soldering the wires are removed, which processes are costly, qualitatively potentially problematic and not easy to control/repeat,

advantages in terms of space since the flat coil occupies less axial space; the self-inductance value may be adjusted by working on the number of turns and on the internal and external diameter of the coil as well as on the shape,

the wire of the coil not being exposed and instead being produced in the support reduces the effects of drift in the sensor in conditions of high humidity (in which, in the case of a traditional coil, parasitic capacitance forms).

By comparison with the device described in WO 2018/171998 A1, the inventors have discovered that the fact that the interaction element passes through allows a frequency-movement characteristic that is much more linear and ensures a greater range of the signal. By contrast, if the interaction element does not pass through, a non-linear and semi-flat curve is obtained for a large part of the travel of the metal element.

### BRIEF DESCRIPTION OF THE FIGURES

Further features and advantages of the present invention will become clear from the detailed description that follows, given purely by way of non-limiting example and with reference to the accompanying drawings, in which:

FIGS. 1 and 2 are sectional views which represent two embodiments of a transducer according to the present invention;

FIG. 3 is an exploded view of the transducer in FIG. 1;

FIG. 4 is a graph which compares the frequency-movement characteristics of a transducer according to the present invention (continuous line) and a transducer according to WO 2018/171998 A1 (dashed line);

FIGS. 5 and 6 are plan views which represent two possible shapes of a coil of the transducer according to the present invention;

FIG. 7 shows the topography of a possible embodiment of a multilayer coil of the transducer according to the present invention;

FIG. 8 is a block diagram of an example of a circuit associated with the coil of the transducer;

FIGS. 9 and 10 are sectional views which represent other two embodiments of the present invention; and

FIGS. 11a and 11b are sectional views which represent the geometric relationships between an interaction element and a turn of the coil of the transducer according to the present invention.

### DETAILED DESCRIPTION

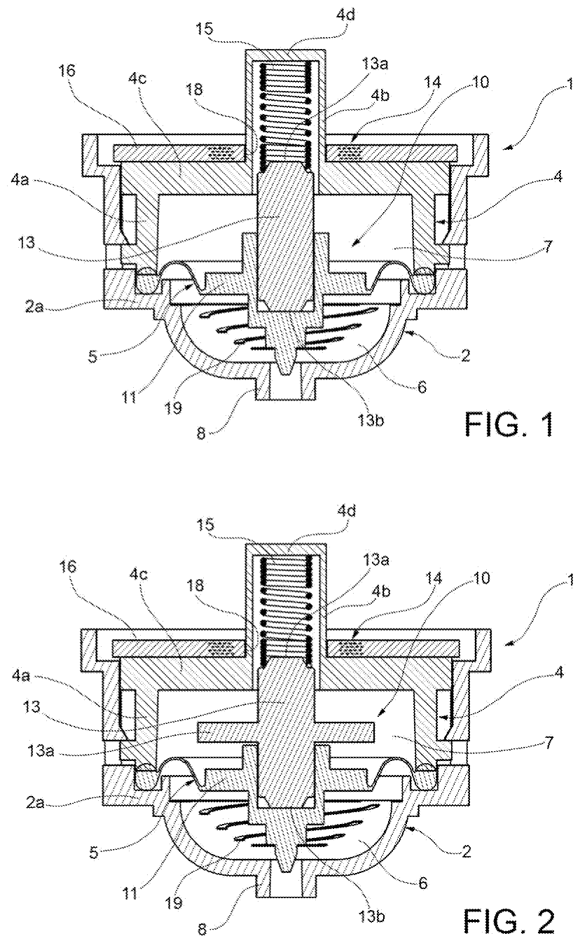

In FIG. 1, reference sign 1 indicates, as a whole, a transducer according to the present invention.

In the embodiment shown by way of example, the transducer 1 is adapted to be used as a differential pressure transducer. However, as will be shown in the following, the present invention is not limited to this type of transducer.

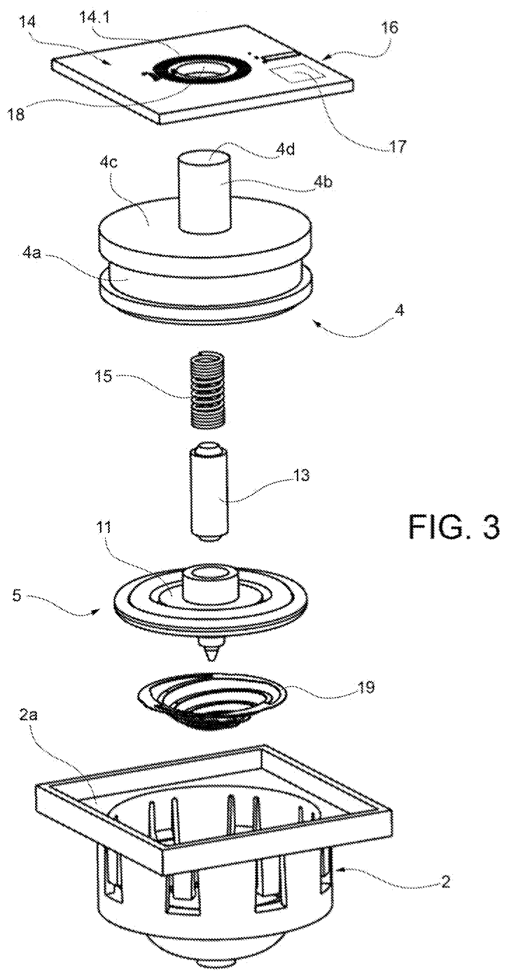

With reference to FIG. 3, the transducer 1 comprises a rigid casing formed by a first element 2 which is shaped substantially like a cup, and a second element (not shown) which is mounted on the cup element 2 like a cover.

A support body, which is indicated as a whole by reference sign 4, is positioned inside the casing of the transducer 1 and, in the example shown, is fixed to the first element 2 of the casing. This body has a lower annular portion 4a and an upper annular portion 4b which are connected to each other by a transverse annular wall 4c.

The end of the tubular portion 4b of the support body 4 is closed by a terminal wall 4d.

Reference sign 5 indicates a resilient membrane, for example consisting of an elastomeric material. The periphery of the resilient membrane is clamped in a fluid-tight manner between the lower annular portion 4a of the support body 4 and a shoulder 2a of the cup body 2.

The resilient membrane divides the region between the lower part of the cup body 2 and the support body 4 into two chambers of variable volume, indicated by reference characters 6 and 7.

The cup element 2 of the casing of the transducer has a tubular connector 8 which allows a fluid to be introduced into the chamber 6. In operation, the instantaneous position of the membrane 5 depends (for example) on the difference between the pressures prevailing in the chambers 6 and 7.

The central portion of the membrane 5 is connected to a movable part indicated as a whole by reference sign 10. This part comprises a washer 11 which is secured to the membrane 5 and to which an elongate element 13 made of ferromagnetic material, for example ferrite, is fixed. The elongate element is also referred to as interaction element hereinafter.

With respect to the direction of movement determined by the membrane 5, which in the following is also defined as the axial direction, the interaction element 13 extends between a first end 13a thereof and a second end 13b thereof. The interaction element 13 extends in part axially into the upper tubular portion 4b of the support body 4.

In the embodiment shown, a helical spring 15 is arranged between the terminal wall 4d of the support body 4 and the first end 13a of the interaction element 13. A further spring 19, which has a substantially conical shape, is arranged in the chamber 6 between the washer 11 and the lower wall of the cup body 2.

A circuit board 16 is fixed to the terminal part 4d of the support body 4 on the opposite side to the membrane. The circuit board carries components and circuits of a kind known per se that are represented in a simplified manner in FIG. 3 by a rectangle indicated by 17.

A coil 14 is connected to the circuits and comprises at least one turn formed by a pattern of flat conductive tracks 14.1 formed on the circuit board 16. The term “flat” is conventionally understood to mean that the tracks have a cross section such that the thickness of the track (i.e. the cross-sectional dimension of the track in the direction orthogonal to the support surface) is much smaller than the width of the track (i.e. the cross-sectional dimension of the track in the direction parallel to the support surface), for example less by at least one order of magnitude. This pattern of conductive tracks may be made using various technologies that are already available such as vacuum deposition, laser structuring and plating, selective plating, or activation of the support. Alternatively, the coil may be made by cutting sheets of conductive material (or material which has been made conductive using surface treatments) and then fixed to the support.

A hole or recess 18 is formed in the circuit board 16, and is configured to receive the interaction element 13 in such a way that the first end 13a (i.e. the end of the interaction element closest to the coil 14) may be positioned flush with at least one turn T of the coil 14 (see FIG. 11a) or beyond the turn T of the coil 14 (see FIG. 11b). For the purposes of the present invention, “configured to receive” is understood to mean that, in operation, after the movement of the membrane, the hole or recess is intended to receive an interaction element which, in the rest position, is normally arranged outside the hole or recess, but it is also understood that the interaction element may be received or accommodated in the hole or recess even when in the rest position. The first end 13a being “beyond” the reference turn T of the coil 14 is understood to be when the first end 13a is positioned to one side of the turn, which side is opposite to the side of the turn on which the second end 13b is positioned (see FIG. 11b). If the coil 14 comprises a plurality of turns arranged on different levels with respect to the direction of movement of the interaction element 13, the reference turn T of the coil 14 is the turn on the side of the coil 14 from which the interaction element 13 enters when the membrane 5 is stressed.

In the example shown, the hole or recess 18 is formed as a through hole and is surrounded by the coil 14. According to alternative embodiments which are not shown, the hole or recess 18 may be formed as a blind hole. In the following, an embodiment will be described in which the hole or recess 18 is not surrounded by the coil.

When in operation as a differential pressure transducer, the instantaneous position of the membrane 5 depends on the difference between the fluid pressures in the chambers 6 and 7. As this difference varies, the movable part 10 moves axially relative to the coil 14. As the coupling between the interaction element 13 and this coil 14 varies, the self-inductance exhibited by the latter varies.

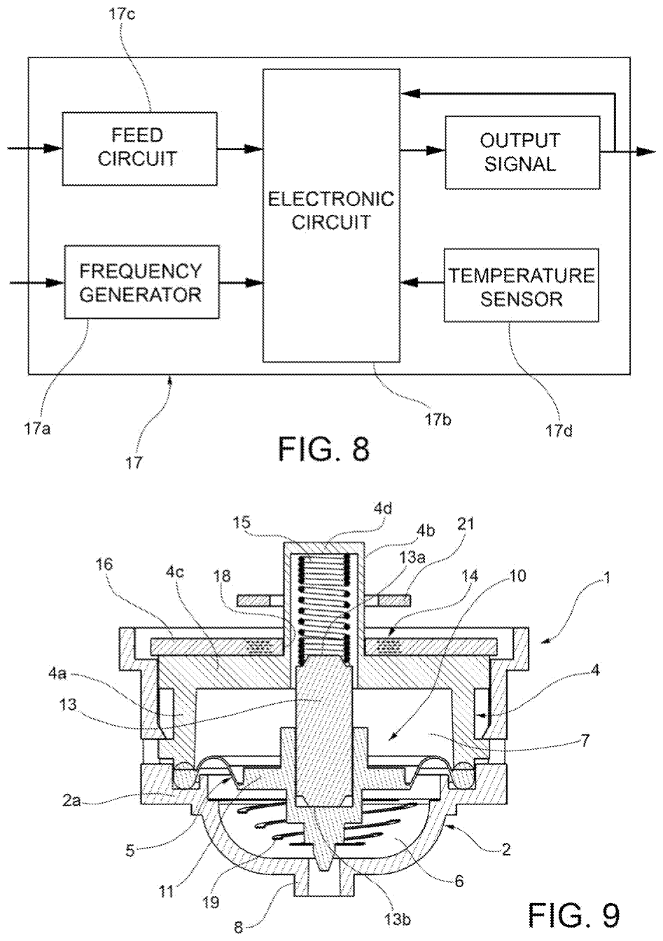

FIG. 8 shows a possible embodiment of the circuits 17 carried by the circuit board 16. These circuits may comprise a frequency generator 17a connected to the coil 14, for example a Colpitts oscillator, the oscillation frequency of which varies as a result of the variation in self-inductance of the coil 14, and an electronic processing circuit 17b which reads the variation in frequency and generates an electrical output signal. The circuit board 16 is configured to be connected to an electronic control unit (not shown) of the apparatus in which the transducer 1 is intended to be installed, in order to transmit the electrical output signal to the electronic control unit. The circuits 17 also comprise a feed circuit 17c adapted to be connected to the external electronic control unit. Further components may also be arranged on the circuit board 16, such as flow meters or electrical connections to other actuators/sensors, for example optical actuators/sensors or conductivity, temperature or humidity sensors, etc. In particular, a temperature sensor 17d, for example an NTC sensor, may be provided. Said sensor is configured to provide a temperature signal indicative of ambient temperature, which signal is processed by the electronic circuit 17b in order to compensate for the frequency output signal.

According to one embodiment which is not shown, the coil 14 may be made on a support which is separate from the circuit board 16 and which may be rigid or flexible.

In the example described above, the interaction element 13 is coupled to the membrane 5 and is therefore movable, while the coil 14 is fixed to the stationary part of the transducer 1. In an alternative embodiment which is not shown, the coil is coupled to the membrane and is therefore movable, while the interaction element is fixed to the stationary part of the transducer. According to other embodiments, both the coil and the interaction element may be movable.

FIG. 2 shows another embodiment of the invention. Elements corresponding to those in FIGS. 1 and 3 have been assigned the same reference signs and will not be described again. The embodiment in FIG. 2 differs from that in FIG. 1 on account of the shape of the interaction element 13, which in FIG. 2 has a disc-shaped extension extending radially from the main body of the interaction element 13.

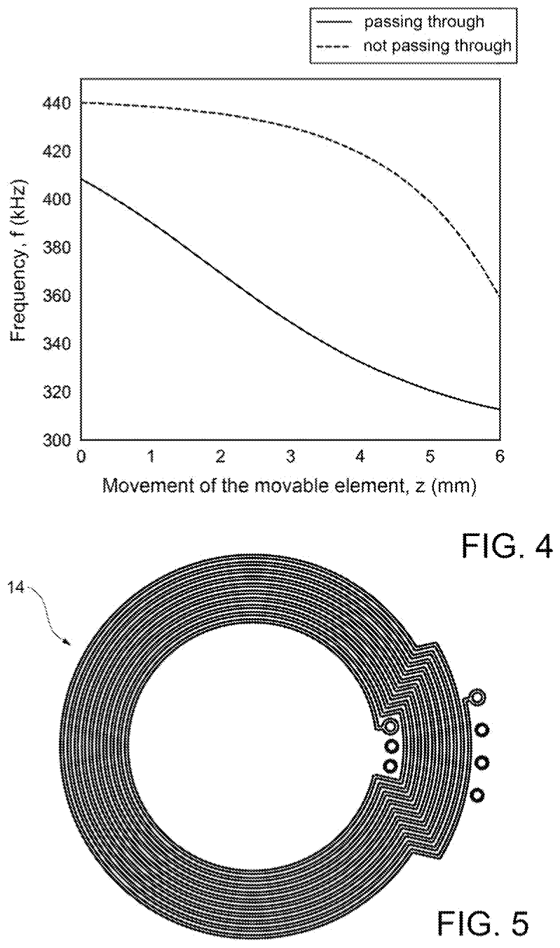

FIG. 4 is a graph which compares the frequency-movement characteristics of the transducer described above (continuous line) and a transducer according to WO 2018/171998 A1 (dashed line). The fact that the interaction element passes through the coil makes it possible to have a frequency-movement characteristic that is much more linear and ensures a greater range of the signal. In contrast, if the interaction element does not pass through, a non-linear and semi-flat curve is obtained for a large part of the travel of the interaction element.

In the embodiments described above, the coil is planar, and the following description cites possible examples of this preferred configuration; however, the present invention also provides for non-planar coils.

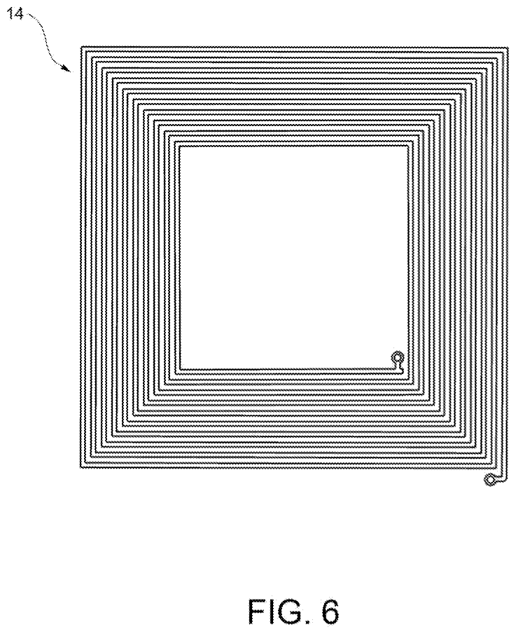

The coil 14 may comprise one single turn or a plurality of turns arranged on the same plane and/or on different levels. The turns may be ring-shaped or arranged in a spiral. They may be square-shaped, polygonal with a number of sides greater than 4, circular or oval, or have other irregular shapes; these shapes may be advantageous in terms of the self-inductance generated (see for example IEEE Journal of Solid State Circuits, vol. 34, no. 10, October 1999—Simple Accurate Expression for Planar Spiral Inductances) and/or make it possible to minimize the distance to the interaction element in order to maximize the resolution of the transducer. By way of example, FIGS. 5 and 6 show two possible shapes of a spiral coil 14. In the example in FIG. 5, the turns of the coil 14 have an approximately overall circular shape, with a portion of each turn being staggered with respect to the remainder of the turn. In the example in FIG. 6, the turns of the coil have an approximately square shape.

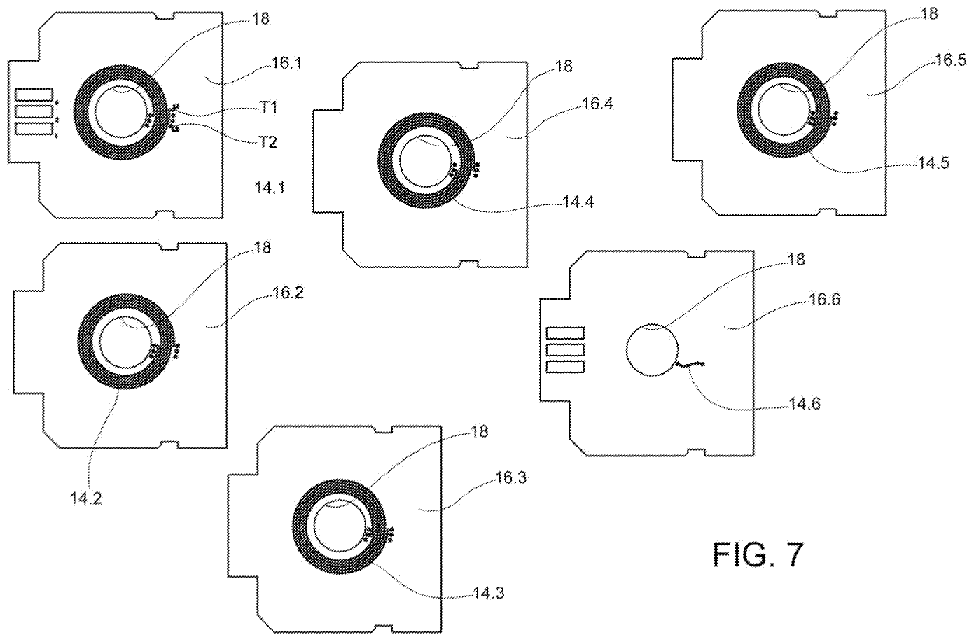

According to one embodiment, the coil 14 may comprise a plurality of layers of conductive track that are electrically connected to each other. For this purpose, the support 16 of the coil 14 may be multi-layered, and the various layers of conductive track may be connected to each other by means of vias made through the various layers of the support. By way of example, FIG. 7 represents a possible embodiment of a multilayer coil 14. Reference signs 16.1-5 indicate the layers of the support 16, while 14.1-14.5 indicate the layers of conductive track that form the multilayer coil 14. Reference signs T1 and T2 indicate the terminal contacts of the coil 14. In the support layer 16.6, the conductive track layer 14.6 forms a bridge which establishes the electrical connection between an end of the adjacent conductive track layer 14.5 and the terminal contact T2. In general, the layers of conductive track may be arranged such that adjacent layers have a concordant or discordant direction of current circulation.

More generally, each layer of conductive track may have a different shape and/or number of turns from the adjacent layers. The coil may also be formed only on internal layers (and not all of the layers available in the support) so as to reduce the parasitic capacitances in particular environmental conditions.

FIG. 9 shows another embodiment of the invention. Elements corresponding to those in FIGS. 1 and 3 have been assigned the same reference signs and will not be described again. The embodiment in FIG. 9 differs from the embodiment in FIG. 1 in that it comprises an annular magnetic circuit element 21 adapted to interact magnetically with the interaction element 13. The magnetic circuit element 21 is stationary relative to the coil 14 and arranged co-axially with the interaction element 13. This additional element makes it possible to improve the magnetic circuit formed by the interaction element 13 when the interaction element is moved; in so doing, the frequency-movement characteristic is more linear and has a greater range. In the example shown, the magnetic circuit element 21 is fixed to the support body 4 of the transducer in a per se manner known, and is arranged on the side of the coil 14 opposite to the side of the coil 14 from which the interaction element 13 enters.

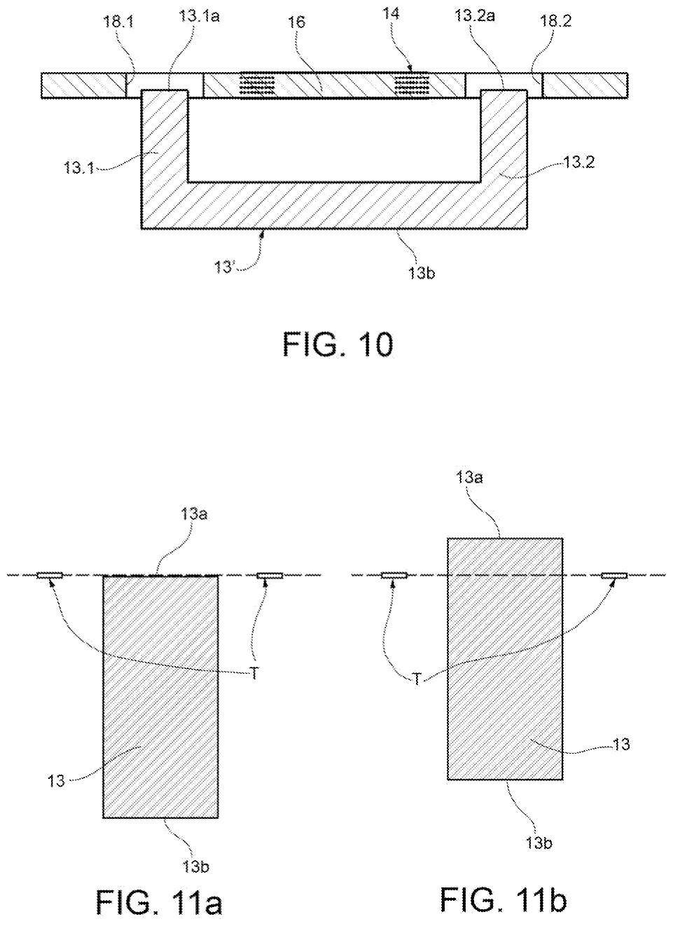

FIG. 10 shows a further embodiment of the present invention. Elements corresponding to those in FIGS. 1 and 3 have been assigned the same reference signs and will not be described again. The embodiment in FIG. 10 differs from the preceding embodiments in that the interaction element, now indicated by reference sign 13′, is located outside the space delimited by the coil 14. In the example shown, the interaction element 13′ has an approximately horseshoe shape, having two elongate arms 13.1 and 13.2 extending in the relative direction of movement of the interaction element 13′ with respect to the coil 14. The interaction element 13′ therefore has two first ends, indicated by 13.1a and 13.2a, and the coil support 16 has two holes or recesses 18.1 and 18.2 arranged in approximately diametrically opposing positions with respect to the coil 14 and outside the space delimited by the coil 14. The two holes or recesses 18.1 and 18.2 are configured to receive the interaction element 13′ in such a way that the first ends 13.1a and 13.2a may be positioned flush with at least one turn of the coil 14, or may be positioned beyond this turn of the coil 14.

A transducer according to the present invention may be used to transduce physical quantities in electrical signals, which physical quantities are different from a pressure but, in any case, are capable of causing a relative movement of the interaction element with respect to the coil.

The principle of the invention remaining unchanged, embodiments and constructional details may be greatly modified with respect to those described and illustrated purely by way of non-limiting example, without thereby departing from the scope of protection as described and claimed herein.

What is claimed is:

1. An electrodynamic position transducer comprising
a rigid, hollow casing in which a membrane is clamped, said membrane together with a portion of the rigid, hollow casing defining at least one chamber of variable volume;
a coil comprising at least one turn formed by a pattern of flat conductive tracks formed on a coil support made of insulating material;
an interaction element configured to interact magnetically with the coil as a result of a movement of the membrane, in such a way that a self-inductance of said coil is variable depending on a relative position of the interaction element with respect to the coil, and
a circuit coupled to said coil and configured to provide an output signal, a parameter of said output signal being indicative of the self-inductance of said coil;
wherein at least one hole or recess is formed in the coil support, said hole or recess being configured to receive said interaction element in such a way that one end of the interaction element is positionable flush with said at least one turn or beyond said at least one turn.

2. The electrodynamic position transducer of claim 1, wherein one of said interaction element and coil is movable relative to the rigid, hollow casing and is coupled to the membrane.

3. The electrodynamic position transducer of claim 1, wherein said coil comprises a plurality of conductive track layers which are electrically connected to each other and alternate with layers of said coil support.

4. The electrodynamic position transducer of claim 1, wherein said circuit is arranged on the coil support.

5. The electrodynamic position transducer of claim 1, wherein said circuit comprises a temperature sensor configured to provide a temperature signal indicative of ambient temperature, and an electronic processing circuit configured to compensate for said output signal on the basis of the temperature signal.

6. The electrodynamic position transducer of claim 1, wherein the coil is planar.

7. The electrodynamic position transducer of claim 6, wherein the coil surrounds said at least one hole or recess, and wherein an annular magnetic circuit element configured to interact magnetically with the interaction element is provided, said annular magnetic circuit element being stationary relative to the coil and arranged co-axially with the interaction element.
